(19) United States
(12) Patent Application Publication
(10) Pub. No.: US 2018/0181576 A1
(43) Pub. Date: Jun. 28, 2018

(54) Real-Time Transmittal Of Optimized Map Vector Tile Data

(71) Applicant: Mapbox, Inc., San Francisco, CA (US)

(72) Inventors: Carol B. Hansen, Washington, DC (US); Samuel V. Matthews, Seattle, WA (US); Jacob R. Pruitt, San Francisco, CA (US)

(21) Appl. No.: 15/388,931

(22) Filed: Dec. 22, 2016

(51) Int. Cl. G06F 17/30; G06K 9/00

(52) U.S. Cl. CPC G06F 17/30061; G06K 9/00503; G06F 17/30241

(57) ABSTRACT

A method comprises receiving, at a server computer, a request for a map tile, wherein the request specifies a map style, and wherein the map tile has been previously digitally stored and comprises a plurality of digital electronic map data of a portion of a geographical map; based on the map style and the map tile identified in the request, generating an optimized map tile, wherein the optimized map tile comprises less than all of the plurality of electronic map data of the map tile identified in the request; and sending the optimized map tile to the client map application.

### FIELD OF THE DISCLOSURE

The technical field of the present disclosure generally relates to improved methods, computer software, and/or computer hardware in the field of electronic mapping. More specifically, the present disclosure relates to computer-implemented techniques for creating and transmitting style-optimized vector map tile data for use in a client map application program.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Digitally stored electronic maps can be used to provide directions to users of mobile devices, for example, using any of a wide array of standalone map or direction application programs or apps. Software associated with electronic maps can correctly determine where a mobile device is within a few feet or meters, or show where the user of that mobile device is on the electronic map in real time. Electronic maps also typically include other functionality, such as providing turn by turn directions to nearly any location. Additional elements such as traffic or wrecks may also be shown.

Electronic maps also appear in other applications aside from standalone mapping applications. For example, ride sharing applications, taxi applications, video games, and other applications may use digital maps. These or other applications can obtain electronic maps by calling a map server computer through an Application Programming Interface (API). Thus, a single electronic map provider that owns or operates the server computer may supply the electronic maps for many different applications.

The electronic map provider may store electronic map data for the many different map applications. However, not all applications require the same set of data. Each application may only use a portion of electronic map data it receives. Sending unnecessary map data is an inefficient use of device memory and network bandwidth, but storing a separate set of map data for each application requires a large amount of storage. Data links between a mobile computing device and server computer may have low bandwidth or high cost, as in the case of some cellular radiotelephone data links. Thus, improved methods for providing electronic map data are needed.

### SUMMARY

The appended claims may serve as a summary of the invention.

### BRIEF DESCRIPTION OF THE DRAWINGS

In the drawings:

FIG. 1 illustrates an example computer system in which the techniques described herein may be practiced, in an embodiment.

FIG. 2 illustrates a programmable algorithm or method in accordance with an embodiment.

FIG. 3A illustrates an example map tile and an example optimized map tile.

FIG. 3B illustrates an example map data layer and an example optimized map data layer.

FIG. 4 illustrates a computer system upon which an embodiment may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

The text of this disclosure, in combination with the drawing figures, is intended to state in prose the algorithms that are necessary to program a computer to implement the claimed inventions, at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement the inventions claimed herein.

Embodiments are described in sections below according to the following outline:

### 1.0 GENERAL OVERVIEW

### 2.0 SYSTEM OVERVIEW

2.1 MOBILE COMPUTING DEVICE

2.2 SERVER COMPUTER

2.3 DATABASE
2.3.1 ELECTRONIC MAP SOURCE DATA
2.3.2 ELECTRONIC MAP DATA
2.3.3 MAP STYLE DATA
2.3.4 MAP TILE FILTER

2.4 MAPPING APPLICATION
3.0 PROCESS OVERVIEW
4.0 IMPLEMENTATION EXAMPLE—HARDWARE OVERVIEW

### 1.0 GENERAL OVERVIEW

Computer-implemented techniques are provided for real-time transmittal of optimized map vector tile data to a client map application. In an embodiment, a request for a map tile is received; the request specifies a map style. The map tile has been previously digitally stored and comprises a plurality of digital electronic map data of a portion of a geographical map. Based on the map style and the map tile identified in the request, an optimized map tile is generated. The optimized map tile comprises less than all of the plurality of electronic map data of the map tile identified in the request. In an embodiment, the optimized map tile comprises electronic map data defining one or more map data layers for which a visual style is defined by the map style. Additionally or alternatively, the optimized map tile comprises electronic map data defining one or more map features of the one or more map data layers. The optimized map tile is sent to the client map application.

In an embodiment, a map tile filter is generated based on the map style. The map tile filter is applied to the plurality of electronic map data to generate the optimized map tile. In an embodiment, the map tile filter is cached in memory. In response to a second request for a second map tile, wherein the second request specifies the same map style, the map tile filter that is in the cache is applied to generate a second optimized map tile.

In an embodiment, the request for the map tile is received asynchronously as the client map application is running on a client computing device. The optimized map tile is generated within a period of time that is sufficient for the client map application to receive and cause displaying the map tile as part of a continuously generated visual map in a display of the client computing device.

Other embodiments, aspects, and features will become apparent from the disclosure as a whole. These techniques have the benefit of creating and transmitting, from a server computer storing map data to a remote client map application, only the map tile data that the client map application needs. Therefore, embodiments can achieve significant reductions in data size, use of network bandwidth, and use of CPU cycles at the client computing device.

### 2.0 SYSTEM OVERVIEW

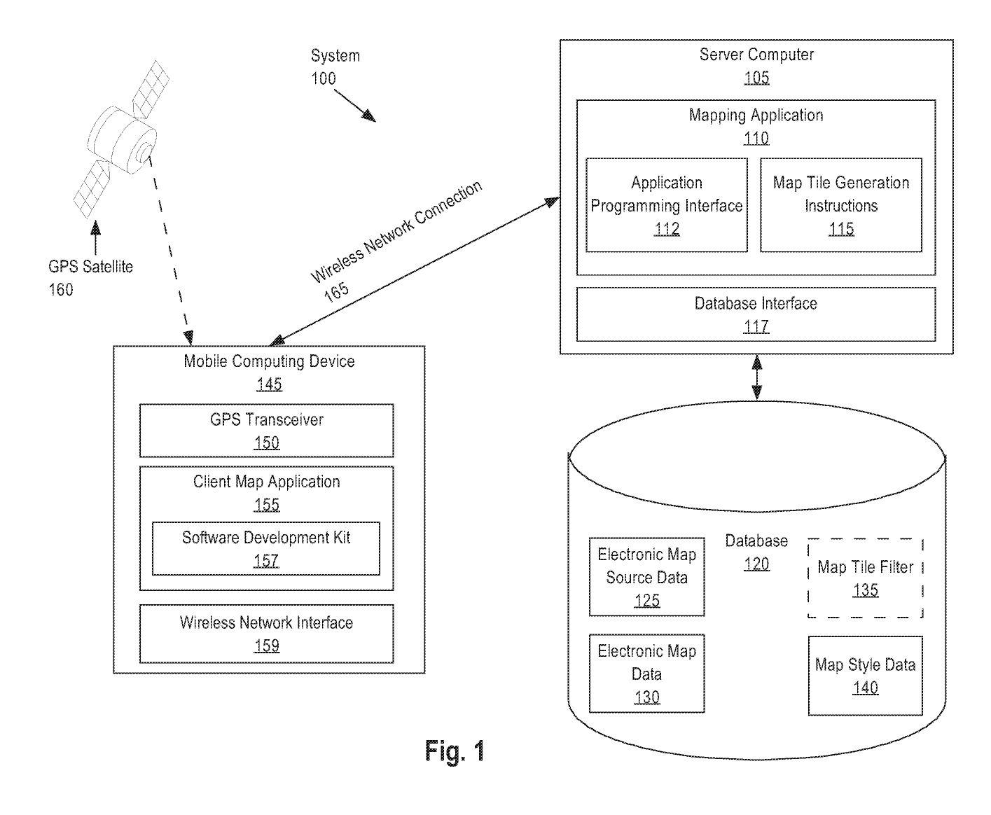

FIG. 1 illustrates an example computer system in which the techniques described may be practiced, according to one embodiment.

In an embodiment, a computer system 100 comprises a plurality of components that may be implemented at least partially by hardware at one or more computing devices, such as one or more hardware processors executing stored program instructions stored in one or more memories for performing the functions that are described herein. In other words, in an embodiment, all functions described herein are intended to indicate operations that are performed using programming in a special-purpose computer or general-purpose computer, in various embodiments. FIG. 1 illustrates only one of many possible arrangements of components configured to execute the programming described herein. Other arrangements may include fewer or different components, and the division of work between the components may vary depending on the arrangement.

FIG. 1 illustrates a mobile computing device 145 that is coupled via a wireless network connection 165 to a server computer 105, which is coupled to a database 120. A GPS satellite is coupled via a wireless connection to the mobile computing device 145. The server computer comprises a mapping application 110, an application programming interface (API) 112, turn restriction detection instructions 115 and a database interface 117. The database 120 comprises electronic map source data 125, electronic map data 130, map tile filter 135, map style data 140. The mobile computing device 145 comprises a GPS transceiver 150, client map application 155, software development kit (SDK) 157, and wireless network interface 159

2.1 Mobile Computing Device

In one embodiment, mobile computing device 145 is any mobile computing device, such as a laptop, hand-held computer, wearable computer, cellular or mobile phone, portable digital assistant (PDA), portable navigation device, or tablet computer. Additionally or alternatively, mobile computing device 145 is a navigation system installed in a car or other vehicle. Although a single mobile computing device is depicted in FIG. 1, any number of mobile computing devices may be present. Each mobile computing device 145 is communicatively connected to server computer 105 through wireless network connection 165 which comprises any combination of a LAN, a WAN, one or more internetworks such as the public Internet, a cellular network, or a company network.

In an embodiment, mobile computing device 145 is communicatively coupled to GPS satellite 160 using GPS transceiver 150. GPS transceiver 150 is a transceiver used by mobile computing device 145 to receive signals from GPS satellite 160, which broadly represents three or more satellites from which the mobile computing device may receive signals for resolution into a latitude-longitude position via triangulation calculations.

Mobile computing device 145 also includes wireless network interface 159, which is used by the mobile computing device 145 to communicate wirelessly with other devices. In particular, wireless network interface 159 is used to establish wireless network connection 165 to server computer 105. Wireless network interface 159 may use WiFi, WiMAX, Bluetooth, ZigBee, cellular standards, or others.

Mobile computing device 145 also includes other hardware elements, such as one or more input devices, memory, processors, and the like, which are not depicted in FIG. 1. Mobile computing device 145 also includes applications, software, and other executable instructions to facilitate various aspects of embodiments described herein. These applications, software, and other executable instructions may be installed by a user, owner, manufacturer, or other entity related to mobile computing device. In one embodiment, mobile computing device 145 includes client map application 155 which is software that displays, uses, supports, or otherwise provides electronic mapping functionality as part of the application or software. Client map application 155 may be any type of application, such as a taxi service, a video game, a chat client, a food delivery application, etc. In an embodiment, client map application 155 obtains electronic mapping functions through SDK 157, which may implement functional calls, callbacks, methods, or other programmatic means for contacting the server computer to obtain digital map tiles, layer data, or other data that can form the basis of visually rendering a map as part of the application. In general, SDK 157 is a software development kit that allows developers to implement electronic mapping without having to design all of the components from scratch. For example, SDK 157 may be downloaded from the Internet by developers, and subsequently incorporated into an application which is later used by individual users.

2.2 Server Computer

Server computer 105 may be any computing device, including but not limited to: servers, racks, work stations, personal computers, general purpose computers, laptops, Internet appliances, wireless devices, wired devices, multi-processor systems, mini-computers, and the like. Although FIG. 1 shows a single element, the server computer 105 broadly represents one or more multiple server computers, such as a server cluster, and the server computer 105 may be located in one or more physical locations. Server computer 105 may also represent one or more virtual computing instances that execute using one or more computers in a datacenter such as a virtual server farm.

Server computer 105 is communicatively connected to database 120 and mobile computer device 145 through any kind of computer network using any combination of wired and wireless communication, including, but not limited to: a Local Area Network (LAN), a Wide Area Network (WAN), one or more internetworks such as the public Internet, or a company network. Server computer 105 may host or execute mapping application 110, and may include other applications, software, and other executable instructions, such as database interface 117, to facilitate various aspects of embodiments described herein.

In one embodiment, database interface 117 is a programmatic interface such as JDBC or ODBC for communicating with database 120. Database interface 117 may communicate with any number of databases and any type of database, in any format. Database interface 117 may be a piece of customer software created by an entity associated with mapping application 110, or may be created by a third party entity in part or in whole.

2.3 Database

In one embodiment, database 120 is a data storage subsystem consisting of programs and data that is stored on any suitable storage device such as one or more hard disk drives, memories, or any other electronic digital data recording device configured to store data. Although database 120 is depicted as a single device in FIG. 1, database 120 may span multiple devices located in one or more physical locations. For example, database 120 may include one or more nodes located at a data warehouse(s). Additionally, in one embodiment, database 120 may be located on the same device(s) as server computer 105. Alternatively, database 120 may be located on a separate device(s) from server computer 105.

Database 120 may be in any format, such as a relational database, a noSQL database, or any other format. Database 120 is communicatively connected with server computer 105 through any kind of computer network using any combination of wired and wireless communication of the type previously described. Optionally, database 120 may be communicatively connected with other components, either directly or indirectly, such as one or more third party data suppliers. Generally, database 120 stores data related to electronic maps including, but not limited to: electronic map source data 125, electronic map data 130, map tile filter 135, and map style data 140. These datasets may be stored, for example, as columnar data in a relational database or as flat files.

2.3.1 Electronic Map Source Data

In one embodiment, electronic map source data 125 is raw digital map data that is obtained, downloaded, or received from a variety of sources. The raw digital map data may include satellite images, digital street data, building or place data, or terrain data. Example sources include National Aeronautics and Space Administration (NASA), United States Geological Survey (USGS), and DigitalGlobe. Raw digital map data may also be defined by a user and uploaded to the server computer. Electronic map source data 125 may be updated at any suitable interval, and may be stored for any amount of time. Once obtained or received, electronic map source data 125 is used to generate electronic map data 130.

2.3.2 Electronic Map Data

In one embodiment, electronic map data 130 is digital map data that is provided, either directly or indirectly, to client map applications, such as client map application 155, using an API. Electronic map data 130 is based on electronic map source data 125. Specifically, electronic map source data 125 is processed and organized as a plurality of vector map tiles which may be subject to map style data to impose different display styles. Electronic map data 130 may be updated at any suitable interval, and may include additional information beyond that derived from electronic map source data 125.

In an embodiment, electronic map data is divided into a plurality of vector map tiles at a plurality of zoom levels, wherein each map tile corresponds to a portion of a geographic map. For example, a map tile may correspond to a square area of a geographic map at a particular zoom level, or an area of a pre-defined size and location within a geographic map. In an embodiment, the portion of electronic map data within each map tile may be organized in a compact, structured format, such as the Mapbox Vector Tile Specification format, by Mapbox, Inc., San Francisco, Calif. Additionally or alternatively, electronic map data 130 may comprise a plurality of map tile sets. A first set of map tiles may include electronic map data derived from a first set of electronic map source data, while a second set of map tiles may include electronic map data derived from a second set of electronic map source data.

In an embodiment, a map tile contains data describing map geometries, such as points, lines, and polygons, of features on the map. Additionally or alternatively, the map tile contains metadata, such as road names, place names, house numbers, feature types, and other properties. For example, electronic map data in a vector map tile corresponding to a portion of a geographic map may include geometry data representing roads, buildings, water, parks, and etc. to be depicted within the portion of the geographic map, as well as geometries for suggested placement of labels and other cartographic features. The map tile may also include metadata corresponding to each feature, such as names that can be rendered as labels on a digital map. Additionally or alternatively, the metadata includes data indicating the portion of the geographic map that the map tile corresponds to. For example, the metadata may include data indicating one or more coordinates of the map tile or one or more boundaries of the map tile.

In an embodiment, electronic map data is further organized into a plurality of data layers. Electronic map data may describe a plurality of map features, such as buildings, water, roads, etc. The map features may be grouped into the plurality of data layers. For example, a “Road” data layer may include map features such as street, bridges, freeways, paths, and etc. As another example, a “Water” data layer may include map features such as rivers, lakes, oceans, canals, and etc.

In an embodiment, map tiles are used by program libraries and SDKs, such as SDK 157, as part of displaying maps on a mobile computing device or a browser. A map application or a browser may request one or more map tiles and process the map tiles to cause display of a visual map.

In an embodiment, map tiles are rendered when requested by a client, like a web browser or a mobile application. Rendering may be performed by a rendering library of a client map application or on a server computer. Example rendering libraries include, but are not limited to, Mapbox GL JS, available from Mapbox, Inc., San Francisco, Calif., the Mapbox iOS SDK, Mapbox Android SDK, the Mapbox GL native renderer, or through a Mapbox API.

In an embodiment, a map tile is rendered based on a map style. Each map style of a plurality of map styles can be used to render the same map tile. In other words, the same portion of electronic map data may be displayed in a variety of visual styles. For example, in one map application, map tiles may be displayed with dark colors while in a second map application, map tiles may be displayed with light colors. Additionally or alternatively, the electronic map data required may differ based on map style. For example, in one map application, roads within a map tile may be displayed while buildings are not displayed. In another map application, landscape and rivers may be displayed while roads are not displayed.

2.3.3 Map Style Data

In one embodiment, map style data 140 is digital data that defines one or more visual map styles for electronic maps. Map style data 140 may comprise a plurality of map styles. A map style defines the visual appearance of an electronic map, such as what map data to display in the electronic map, what order to render the data in, and how to style the data when it is rendered. In an embodiment, a map style may include information including, but not limited to, references to portions of electronic map data 130, map images, fonts, and rules specifying how the portions of electronic map data 130 should be styled when rendering a digital map, such as colors, line styles, line thickness, and etc.

In an embodiment, each map style may be stored as a document. For example, a map style may be stored as a JSON object that adheres to a particular style format specification. A map style may be generated using a map editing program or written independently and uploaded to a server computer.

In an embodiment, a map style comprises one or more map style layers. Each map style layer may include a reference to a portion of electronic map data and one or more visual style rules to be applied to the portion of electronic map data. In an embodiment, the order in which electronic map data is rendered in the digital map is based on the order of the one or more map style layers within the map style. For the purpose of illustration, assume a map style specifies a first style layer followed by a second style layer. When rendering the digital map, electronic map data for the first style layer may be rendered on top of electronic map data in the second style layer. Thus, map features styled by the second style layer may be hidden by map features that are styled by the first style layer.

In an embodiment, the reference to the portion of electronic map data specifies a particular map data source for the maps style layer. For example, the map style may specify a particular map tile set from a plurality of map tile sets as the map data source for the style layer. Additionally or alternatively, the map style layer may specify a particular data layer within the map tile set to associate with the style layer. For example, a style layer may specify visual style rules for a “Water” data layer of a set of map tiles.

In an embodiment, style layer data may include data indicating a style layer type for a map style layer. A map style layer may be a particular map style layer type, such as lines, polygons, symbols, circles, 3D polygons, and images. Each style layer type has a set of properties for which values may be specified. For example, a line style layer type may include style properties such as line width, line color, line style (solid, dotted, dashed), line cap style, line positioning, etc. Additionally or alternatively, the style layer data may specify property values for one or more style properties associated with the style layer type.

In an embodiment, a style layer may include zero or more style layer filters. A style layer filter selects one or more map features from a data layer. In an embodiment, a style layer filter selects map features based on one or more properties of the map features. Map features that satisfy the style layer filters, if any, are rendered using the visual style rules specified by the style layer. Map features that do not satisfy the style layer filters are not rendered as part of rendering the style layer.

Example style layer filters include existential filters, comparison filters, set membership filters, and combining filters. An existential filter selects map features based on whether a particular map feature property exists or does not exist. For example, an existential filter for a “Label” data layer may select labels that includes a Spanish version of the label name. A comparison filter selects map features based on whether a particular map feature property is equal to, not equal to, greater than, greater than or equals to, less than, or less than or equals to a particular value. For example, a comparison filter for a “Road” data layer may select roads whose classification is “streets.” A set membership filter selects map features based on whether a particular map feature property is or is not part of a set of values. For example, a set membership filter for a “Road” data layer may select roads whose structure is not “bridge” or “tunnel.” A combining filter combines two or more filters using a logical AND, OR, or NOR operator. A combining filter may select map features that satisfy at least a first style layer filter and a second style layer filter. The filters specified by a combining filter may include any type of style layer filter described above. For example, a combining filter may select roads whose classification is “streets” but whose structure is neither “bridge” nor “tunnel.”

In an embodiment a style layer includes data indicating one or more zoom levels for which the visual style applies. For example, the style layer may specify a minimum zoom level and a maximum zoom level. If the zoom level at which the digital map is being rendered is outside the zoom level range specified by the style layer, map features styled by the style layer may not be displayed on the map.

2.3.4 Map Tile Filter

In one embodiment, map tile filter 135 is a filter that may be applied to a vector map tile to generate a style optimized map tile. A map tile filter may be generated based on a particular map style. A corresponding map tile filter may be generated for each map style in map style data 140. As indicated by the dotted lines, map tile filter 135 is transiently stored, and may be discarded after a period of time or overwritten by newly generated map tile filters. Additionally or alternatively, a map tile filter may be cached in memory. If a subsequent request for a map tile includes a map style associated with a cached map tile filter, then the cached map tile filter may be used to generate a style optimized map tile for the request, rather than generating a new map tile filter.

In an embodiment, to generate a map tile filter, a map style is analyzed to determine one or more data layers referenced by the map style. Analyzing the map style may include parsing a document storing the map style to determine the one or more layers referenced by the map style. Additionally or alternatively, the map style may be analyzed to determine one or more map features, for each of the one or more data layers, for which a visual style is defined by the map style. Determining one or more map features may include determining one or more map features, of a data layer, that satisfy one or more style layer filters.

In an embodiment, a data layer filter may be generated based on a style layer filter. Each data layer filter may be applied to a portion of electronic map data to determine whether to include the portion of electronic map data in the style optimized map tile. For example, a data layer filter may select data from a “Road” layer whose classification is “freeway.” Data layers that are not the “Road” data layer would not satisfy the data layer filter. Additionally, map features whose classification is not “freeway” would not satisfy the data layer filter. When a map feature satisfies the data layer filter, the map feature is added to the optimized vector tile.

In an embodiment, a map tile filter comprises a set of program instructions. The set of program instructions may be executed as part of generating an optimized map tile. The set of program instructions, when executed, may receive a map tile stored in electronic map data 120, select the portion of electronic map data in the vector tile that satisfies the map tile filter, and generate a new map tile comprising the selected portion of electronic map data. For example, the map tile filter may be a dynamically generated function or method comprising a plurality of data layer filters. The map tile filter may be configured to parse a map tile, determine portions of the map tile that satisfy the plurality of data layer filters, and add the portions of the map tile that satisfy the plurality of data layer filters to a new map tile.

For the purpose of illustrating a clear example, assume that Snippet 1 is an excerpt from a map style stored in map style data 140, and Snippet 2 is pseudocode representing an excerpt from a map tile filter based on the map style.

Snippet 1:

| | |
|---|---|
| Line 01: | { |
| Line 02: | id: “water - lakes”, |
| Line 03: | source: mapbox-streets, |
| Line 04: | source-layer: water, |
| Line 05: | type: polygon, |
| Line 06: | paint: fill-color : blue, |
| Line 07: | filter: [“==” , “class” , “lake”] |
| Line 08: | }, |
| Line 09: | { |
| Line 10: | id: “water - rivers”, |
| Line 11: | source: mapbox-streets, |
| Line 12: | source-layer: water, |
| Line 13: | type: line, |
| Line 14: | paint: line-color : blue, width : 3px, |
| Line 15: | filter: [“==” , “class” , “river”] |
| Line 16: | } |

Snippet 1 defines two style layers called “water—lakes” and “water—rivers.” The style layer data source for both style layers is “mapbox-streets” and the source data layer is “water.” Snippet 1 indicates that the style layer “water—lakes” is a polygon style layer type, and should be colored blue. The style layer “water—lakes” includes a style layer filter that selects map features whose class is equal to “lake.” The style layer “water—rivers” is a line style layer type, with a line color of blue and a width of 3 pixels. The style layer “water—rivers” includes a style layer filter that selects map features whose class is equal to “river.”

Snippet 2:

| | |
|---|---|
| Line 01: | { |
| Line 02: | water: |
| Line 03: | { |
| Line 04: | filters: [“any” , [“==” , “class” , “lake”], [“==” , “class” , “river”] |
| Line 05: | } |
| Line 06: | } |

Snippet 2 defines a portion of a map tile filter based on the style layers specified in Snippet 1. Snippet 2 includes a block corresponding to the “water” data layer and indicates one or more filters for the data layer. The data layer filters in Snippet 2 correspond to the style layer filters specified by the map style layers in Snippet 1. In an embodiment, the filters for a data layer include filters specified by all map style layers that use the data layer as a source data layer. Referring to the above example, the water data layer filter illustrated in Snippet 2 includes filters from the “water—lakes” style layer and the “water—rivers” style layer.

2.4 Mapping Application

In an embodiment, mapping application 110 provides the API 112 that may be accessed, for example, by client map application 155 using SDK 157 to provide electronic mapping to client map application 155. Specifically, mapping application 110 comprises program instructions that are programmed or configured to perform a variety of backend functions needed for electronic mapping including, but not limited to: receiving map tile requests from mobile computing devices, sending electronic map data to mobile computing devices, receiving map style data 140 from map editing applications, processing map styles to generate map tile filter 135, receiving electronic map source data 125 from data providers, processing electronic map source data 125 to generate electronic map data 130, and any other aspects of embodiments described herein. Mapping application 110 includes map tile generation instructions 115 which are programmed or configured to perform map tile generation.

In one embodiment, map tile generation instructions 115 are programmed or configured to receive a request for a map tile, retrieve map data from electronic map data 130, retrieve a map style from map style data 140, and generate an optimized map tile based on the map style and the map data. An optimized map tile is a map tile that comprises a portion of the electronic map data stored in the requested map tile. Additionally or alternatively, map tile generation instructions 115 may generate a map tile filter 135 based on the map style and apply the map tile filter 135 to the map data to generate the optimized map tile.

In an embodiment, an optimized map tile comprises electronic map data for which a visual style is defined by the map style. Generating the optimized map tile based on the map style may involve determining, for each data layer of the map data, whether the map style defines a visual style for the map data layer. Additionally or alternatively, an optimized map tile comprises electronic map data for one or more map features for which a visual style is defined by the map style. Generating the optimized map tile based on the map style may involve determining, for each map feature of the electronic map data, whether the map style defines a visual style for the map feature.

Additionally or alternatively, map tile generation instructions 115 may include instructions to cache an optimized map tile in memory. If the map tile generation instructions receive a subsequent request for the same map tile using the same map style, then the map tile generation instructions 115 may send the cached optimized map tile rather than generating a new optimized map tile.

In an embodiment, map tile generation instructions 115 is configured to receive a request for a map tile asynchronously as a client map application is running on a mobile computing device. Map tile generation instructions 115 may be configured to generate the optimized map tile within a period of time that is sufficient for the client map application to receive and cause displaying the map tile as part of a continuously generated visual map in a display of the mobile computing device. Additionally or alternatively, map tile generation instructions 115 may receive the request for a map tile asynchronously as a server computer is rendering a visual map for display in a browser. Map tile generation instructions 115 may be configured to generate the optimized map tile within a period of time that is sufficient for the server computer to receive and cause rendering the map tile as part of a continuously generated visual map.

For the purpose of illustrating a clear example, the foregoing description has ascribed certain operations, functions, and programming to the map tile generation instructions 115 of FIG. 1. However, in other embodiments, the same operations, functions, and programming may be implemented in programs or logic that is separate from the map tile generation instructions 115, such as a utility program or library. For example, the function of caching a map tile in memory may be implemented in a library that the map tile generation instructions 115 calls. Additionally or alternatively, map tile generation instructions 115 may communicate or interface with any other applications, software, or modules that are executed by server computer 105, such as operating systems or drivers, as needed to implement the functionality described herein.

### 3.0 PROCESS OVERVIEW

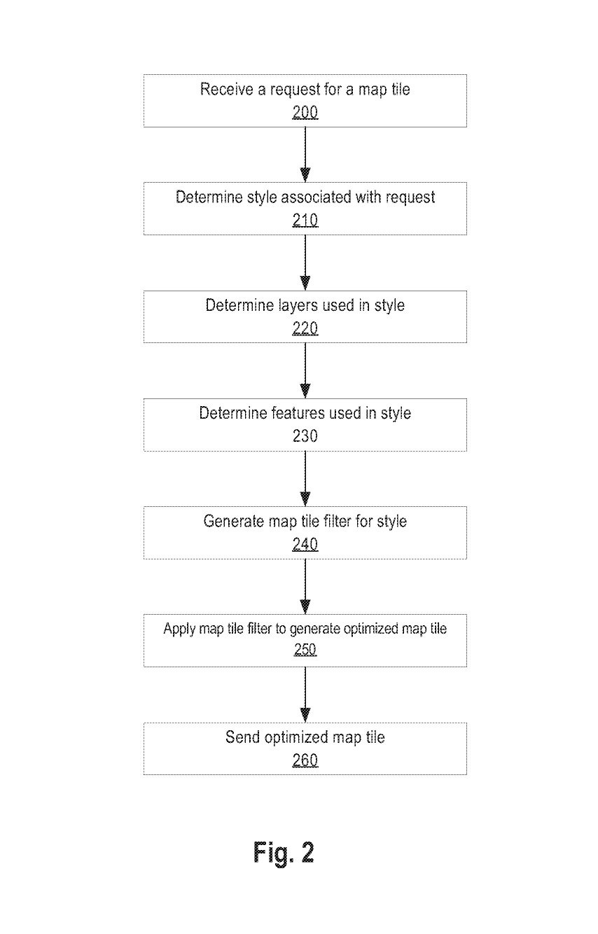

FIG. 2 illustrates an example programmable algorithm or method for generating optimized map tile data.

Although the steps in FIG. 2 are shown in an order, the steps of FIG. 2 may be performed in any order, and are not limited to the order shown in FIG. 2. Additionally, some steps may be optional, may be performed multiple times, and/or may be performed by different components. All steps, operations, and functions of a flow diagram that are described herein are intended to indicate operations that are performed using programming in a special-purpose computer or general-purpose computer, in various embodiments, at the same level of detail that is used by persons of ordinary skill in the art to which the disclosure pertains for communicating with one another about similar computer programs or algorithms. In other words, each flow diagram in this disclosure is a guide, plan or specification of an algorithm for programming a computer to execute the functions that are described.

In step 200, a server computer receives a request for a map tile. The request may be from a client map application on a client computing device or a server computer that provides a rendered map to a client computing device. For example, server computer 105 may receive a request for a map tile from client map application 155 on mobile computing device 145. In an embodiment, the request is received asynchronously as the client map application is running on a mobile computing device or as the server computer is providing a digital map to a browser or map application.

In an embodiment, the request for a map tile specifies a particular map style. If no style is specified, the server computer may be configured to use a default style, or send the original map tile. Additionally or alternatively, the request may include a timestamp or version number associated with a particular map style. The timestamp or version number indicates a particular version of the map style.

In an embodiment, after an optimized map tile is generated, it may be stored in a cache in memory of the server computer. If the request corresponds to a cached optimized map tile, then the server computer may retrieve and send the cached optimized map tile. In an embodiment, the request is a URL specifying a map tile and a map style. For example, the server computer may receive a URL in the example format:

http://api.mapbox.com/zCoord/xCoord/yCoord.mvt?style=styleID

where zCoord indicates a zoom level, xCoord and yCoord indicate an X coordinate and a Y coordinate corresponding to a particular map tile, and styleID indicates a particular map style. The server computer may cache an optimized map tile after generating and sending the optimized map tile. A second request to the same URL may cause the cached optimized map tile to be sent to the client map application.

At step 210, a style associated with the request is determined. In an embodiment, the request includes a style ID identifying a particular map style. The server computer may request or retrieve the map style associated with the style ID from map style data. For example, server computer 105 may retrieve a particular map style stored in map style data 140.

In an embodiment, the request includes a version number or timestamp indicating a particular version of the map style. Map style data 140 may store a plurality of versions of a map style. The server computer may request or retrieve the requested version of the map style from map style data 140. If no map style with the particular timestamp or version number exists, then the server computer may send the original map tile. Additionally or alternatively, map style data 140 stores the current version of each map style. If the version number or timestamp specified by the request does not match the version number or timestamp of the map style stored in map style data 140, then the server computer may send the original map tile.

Based on the map style specified by the request, one or more map features are selected for inclusion in an optimized map tile. At step 220, one or more data layers that have a visual style defined by the map style are determined. In an embodiment, determining the one or more data layers that have a visual style defined comprises parsing the map style to generate a list of data layers referenced by the map style. Additionally or alternatively, the server computer may iterate through each style layer and determine a data layer associated with the style layer.

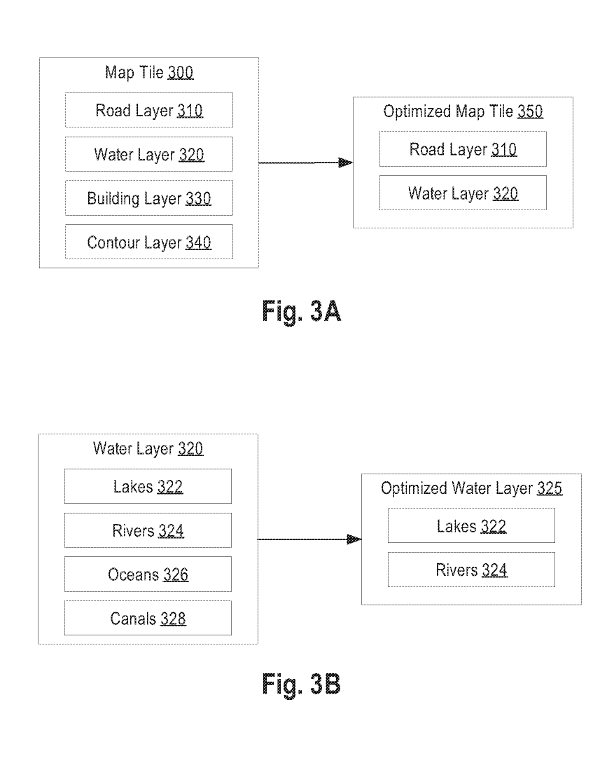

FIG. 3A is a block diagram illustrating an example map tile. Map tile 300 includes Road data layer 310, Water data layer 320, Building data layer 330, and Contour data layer 340. For the purpose of illustration, assume the map style layer includes a first set of style layers that specify Water data layer 320 as a source data layer, a second set of style layers that specify Road data layer 310 as a source data layer, and no style layers specify Building data layer 330 or Contour data layer 340. Optimized map tile 350 is generated based on the map style. Optimized map tile 350 includes Road data layer 310 and Water data layer 320, but does not include Building data layer 330 or Contour data layer 340.

At step 230, one or more map features from the one or more data layers that have a visual style defined by the map style are determined. Determining the one or more map features may include determining which map features from the one or more data layers satisfy one or more map style layer filters defined by the map style. In an embodiment, in order to determine the one or more map features, a corresponding data layer filter is generated based on each map style layer filter.

In an embodiment, each map style layer specified a source data layer and zero or more style layer filters. A data layer filter for the source data layer is created for each style layer filter. If multiple style layers specify the same source data layer, then multiple data layer filters corresponding to different style layers may be created for the same source data layer. If no style layer filters are applied to a source data layer, then all map features from the source data layer are selected. A data layer filter may be generated that selects all data from the source data layer.

In an embodiment, each map style layer comprises data indicating one or more zoom levels for which visual style rules specified by the map style layer applies. If the zoom level of the map tile request is not included in the one or more zoom levels of a map style layer, then the map data specified by the style layer may not be selected for inclusion in the optimized map tile. A data layer filter specifying a zoom level range may be created for the source data layer.

In an embodiment, a map style specifies a plurality of map style layers. The order of the map style layers within the map style determines the order in which map features are rendered on a visual map. A first map feature may be hidden by a second map feature, when the two map features are rendered on the visual map. The hidden map feature may not be selected for inclusion in the optimized map tile. Additionally or alternatively, a map feature may have an opacity property value, which indicates the opacity of the map feature. If the map feature is transparent or invisible, then the map feature may not be selected for inclusion in the optimized map tile.

FIG. 3B is a block diagram illustrating an example map data layer. In this example, a water data layer 320 includes a plurality of map features such as Lakes 322, Rivers 324, Oceans 326, and Canals 328. For purposes of a clear example, assume the map style includes style layer filters that select map features where the classification is equal to “lakes” or where the classification is equal to “rivers.” For example, assume a map style includes only the map style layers illustrated by Snippet 1 above. An optimized map tile based on the map style comprises optimized Water data layer 325. As illustrated in FIG. 3B, optimized Water data layer 325 includes map features Lakes 322 and Rivers 324, but does not include Oceans 326 or Canals 328, as they are not styled by the map style.

At step 240, a map tile filter is generated based on the map style. In an embodiment, generating a map tile filter comprises generating a set of program instructions which, when executed, selects electronic map data for which a visual style is defined by the map style. Additionally or alternatively, the map tile filter may be generated as part of determining the one or more map features in step 230. For example, generating the map tile filter may comprise generating one or more data layer filters.

In an embodiment, the map tile filter is temporarily stored in a cache in memory. Additionally or alternatively, a plurality of map tile filters may be stored in association with a plurality of map styles. Each map tile filter may be mapped to a particular map style. If a subsequent request includes a map style with an associated cached map tile filter, the cached map tile filter may be retrieved, rather than generating a new map tile filter. Additionally or alternatively, if the request includes a map style version, the map style version specified by the request may be compared with the map style version associated with the map tile filter. If the version matches, then the cached map tile filter may be used. If the version does not match, then the cached map tile filter would not be used.

At step 250, an optimized map tile is generated. In an embodiment, generating the optimized map tile comprises applying the map tile filter to electronic map data. Additionally or alternatively, generating the optimized map tile comprises executing a set of program instructions that comprise the map tile filter. Additionally or alternatively, the optimized map tile may be generated as part of determining the one or more map features in step 230. For example, rather than generating a data layer filter to select data from the electronic map data, portions of electronic map data that satisfy a map style layer filter may be directly selected and added to a new map tile.

At step 260, the optimized map tile is sent to the client computer or the server computer that requested the map tile. For example, server computer 105 may send the optimized map tile to client map application 155 on mobile computing device 145.

This process provides the distinct technical benefit of creating and transmitting, from a server computer storing map data to a remote client map application, essentially only the map tile data that the client map application needs. Therefore, embodiments can achieve significant reductions in data size, use of network bandwidth, and use of CPU cycles at the client computing device.

### 4.0 IMPLEMENTATION EXAMPLE—HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

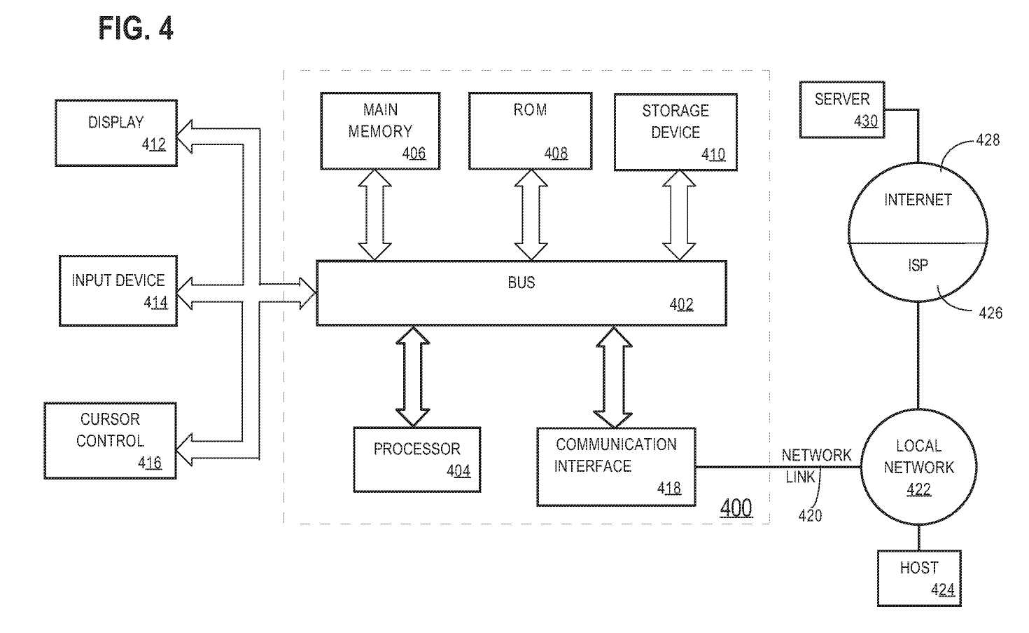

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A data processing method for providing optimized map tiles to a client map application, the method comprising:
receiving, at a server computer, a request for a map tile, wherein the request specifies a map style, and wherein the map tile has been previously digitally stored and comprises a plurality of digital electronic map data of a portion of a geographical map;
based on the map style and the map tile identified in the request, generating an optimized map tile, wherein the optimized map tile comprises less than all of the plurality of electronic map data of the map tile identified in the request; and
sending the optimized map tile to the client map application.

2. The method of claim 1, further comprising:
generating, based on the map style, a map tile filter; and
wherein generating the optimized map tile comprises applying the map tile filter to the plurality of electronic map data.

3. The method of claim 2, wherein the map tile filter comprises a set of program instructions, and applying the map tile filter comprises executing the set of program instructions.

4. The method of claim 2, further comprising:
caching the map tile filter in a cache in memory;
receiving a second request for a second map tile, the second request specifying the map style;
applying the map tile filter that is in the cache to generate a second optimized map tile; and
sending the second optimized map tile to the client map application.

5. The method of claim 1, wherein the plurality of electronic map data defines a plurality of map data layers; the method further comprising:
for each map data layer of the plurality of map data layers: including electronic map data defining the map data layer in the optimized map tile, if the map style defines a visual style for the map data layer.

6. The method of claim 5, wherein each map data layer comprises one or more map features; the method further comprising:
for each map feature of each map data layer: including electronic map data defining the map feature in the optimized map tile, if the map style defines a visual style for the map feature.

7. The method of claim 6, further comprising:
for each map feature of each map data layer:
determining, based on the map style, whether the map feature would be visible if rendered in the client map application; and
including electronic map data defining the map feature in the optimized map tile, only if the map feature would be visible if rendered in the client map application.

8. The method of claim 6, wherein the request specifies a target zoom level, the method further comprising:
for each map feature of each map data layer:
determining, based on the map style, a zoom range associated with the map feature; and
including electronic map data defining the map feature in the optimized map tile if the target zoom level is within the zoom range associated with the map feature.

9. The method of claim 1, wherein the map style defines one or more style layer filters; the method further comprising:
generating, based on the one or more style layer filters, one or more corresponding data layer filters; and
applying the one or more data layer filters to the plurality of electronic map data to generate filtered electronic map data.

10. The method of claim 1, further comprising:
receiving the request for the map tile asynchronously as the client map application is running on a computing device that is separate from the server computer; and
generating the optimized map tile within a period of time that is sufficient for the client map application to receive and cause displaying the map tile as part of a continuously generated visual map in a display of the computing device.

11. The method of claim 1, further comprising:
as part of generating the optimized map tile, transiently storing the optimized map tile in main memory of the server computer; and
overwriting the optimized map tile in the main memory with other data after sending the optimized map tile to the client map application.

12. A server computer for providing optimized map tiles to a client map application, the server computer comprising:
one or more processors;
a memory coupled to the one or more processors and storing one or more sequences of instructions which, when executed using the one or more processors, cause the one or more processors to perform:
receiving a request for a map tile, wherein the request specifies a map style, and wherein the map tile has been previously digitally stored and comprises a plurality of digital electronic map data of a portion of a geographical map;
based on the map style and the map tile identified in the request, generating an optimized map tile, wherein the optimized map tile comprises less than all of the plurality of electronic map data of the map tile identified in the request; and
sending the optimized map tile to the client map application.

13. The server computer of claim 12, the one or more sequences of instructions which, when executed by the one or more processors, further cause the one or more processors to perform:
generating, based on the map style, a map tile filter; and
wherein generating the optimized map tile comprises applying the map tile filter to the plurality of electronic map data.

14. The server computer of claim 13, wherein the map tile filter comprises a set of program instructions, and applying the map tile filter comprises executing the set of program instructions.

15. The server computer of claim 13, the one or more sequences of instructions which, when executed by the one or more processors, further cause the one or more processors to perform:
caching the map tile filter in a cache in memory;
receiving a second request for a second map tile, the second request specifying the map style;
applying the map tile filter that is in the cache to generate a second optimized map tile; and
sending the second optimized map tile to the client map application.

16. The server computer of claim 12, wherein the plurality of electronic map data defines a plurality of map data layers; the one or more sequences of instructions which, when executed by the one or more processors, further cause the one or more processors to perform:
for each map data layer of the plurality of map data layers: including electronic map data defining the map data layer in the optimized map tile, if the map style defines a visual style for the map data layer.

17. The server computer of claim 15, wherein each map data layer comprises one or more map features; the one or more sequences of instructions which, when executed by the one or more processors, further cause the one or more processors to perform:
for each map feature of each map data layer: including electronic map data defining the map feature in the optimized map tile, if the map style defines a visual style for the map feature.

18. The server computer of claim 17, the one or more sequences of instructions which, when executed by the one or more processors, further cause the one or more processors to perform:
for each map feature of each map data layer:
determining, based on the map style, whether the map feature would be visible if rendered in the client map application; and
including electronic map data defining the map feature in the optimized map tile, only if the map feature would be visible if rendered in the client map application.

19. The server computer of claim 17, wherein the request specifies a target zoom level, the one or more sequences of instructions which, when executed by the one or more processors, further cause the one or more processors to perform:
for each map feature of each map data layer:
determining, based on the map style, a zoom range associated with the map feature; and
including electronic map data defining the map feature in the optimized map tile if the target zoom level is within the zoom range associated with the map feature.

20. The server computer of claim 12, wherein the map style defines one or more style layer filters, the one or more sequences of instructions which, when executed by the one or more processors, further cause the one or more processors to perform:
generating, based on the one or more style layer filters, one or more corresponding data layer filters; and
applying the one or more data layer filters to the plurality of electronic map data to generate filtered electronic map data.

21. The server computer of claim 12, the one or more sequences of instructions which, when executed by the one or more processors, further cause the one or more processors to perform:
receiving the request for the map tile asynchronously as the client map application is running on a computing device that is separate from the server computer; and
generating the optimized map tile within a period of time that is sufficient for the client map application to receive and cause displaying the map tile as part of a continuously generated visual map in a display of the computing device.

22. The server computer of claim 12, the one or more sequences of instructions which, when executed by the one or more processors, further cause the one or more processors to perform:
as part of generating the optimized map tile, transiently storing the optimized map tile in main memory of the server computer; and
overwriting the optimized map tile in the main memory with other data after sending the optimized map tile to the client map application.
